(19) United States
(12) Patent Application Publication
(10) Pub. No.: US 2007/0223703 A1
(43) Pub. Date: Sep. 27, 2007

(54) METHOD AND APPARATUS FOR PROVIDING SERVICE KEYS WITHIN MULTIPLE BROADCAST NETWORKS

(76) Inventors: Sanjeev Verma, San Jose, CA (US); Silke Holtmanns, Klaukkala (FI); Pekka Laitinen, Helsinki (FI)

Correspondence Address: DITTHAVONG MORI & STEINER, P.C., 918 Prince St., Alexandria, VA, 22314, US

(21) Appl. No.: 11/548,178

(22) Filed: Oct. 10, 2006

Related U.S. Application Data
(60) Provisional application No. 60/724,569, filed on Oct. 7, 2005.

(51) Int. Cl. H04L 9/00

(52) U.S. Cl. 380/278

(57) ABSTRACT

An approach is provided for providing service keys in multiple broadcast networks. A message including a group of keys is generated for providing secure communication over a first broadcast network and a second broadcast network. A message is transmitted to a terminal within the first broadcast network and a terminal within the second broadcast network. An encrypted service key is broadcast to the terminals, wherein the encrypted service key is decrypted using a portion of the group of keys.

### RELATED APPLICATIONS

This application claims the benefit of the earlier filing date under 35 U.S.C. §119(e) of U.S. Provisional Application Ser. No. 60/724,569 filed Oct. 7, 2005, entitled “Method and Apparatus for Providing Service Keys in a Cellular Network and a Broadcast Network”; the entirety of which is incorporated by reference.

### FIELD OF THE INVENTION

Embodiments of the invention relate to communications, and more particularly, to supporting authentication and establishing secure communications.

### BACKGROUND

Radio communication systems, such as cellular systems (e.g., spread spectrum systems (such as Code Division Multiple Access (CDMA) networks), or Time Division Multiple Access (TDMA) networks) and broadcast systems (e.g., Digital Video Broadcast (DVB)), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves key provisioning for authentication and establishing secure communications for multiple radio communication systems. Unfortunately, this function is not effectively supported by current protocols.

Therefore, there is a need for an approach to deliver keys to users (e.g., subscribers or customers) within two different radio communication systems.

### SOME EXEMPLARY EMBODIMENTS

These and other needs are addressed by the invention, in which an approach is presented for more effectively supporting key management.

According to one aspect of an embodiment of the invention, a method comprises generating a message including a group of keys for providing secure communication over a first broadcast network and a second broadcast network. The method also comprises transmitting the message to a terminal within the first broadcast network and a terminal within the second broadcast network. The method also comprises broadcasting an encrypted service key to the terminals, wherein the encrypted service key is decrypted using a portion of the group of keys.

According to another aspect of an embodiment of the invention, an apparatus comprises a key management entity configured to generate a message including a group of keys for providing secure communication over a first broadcast network and a second broadcast network, wherein the message is transmitted to a terminal within the first broadcast network and a terminal within the second broadcast network, An encrypted service key is broadcast to the terminals, and the encrypted service key is decrypted using a portion of the group of keys.

According to another aspect of an embodiment of the invention, a method comprises receiving a message including a group of keys for providing secure communication over a first broadcast network and a second broadcast network. The method also comprises receiving a broadcast message specifying an encrypted service key. The method further comprises decrypting the encrypted service key using a portion of the group of keys.

According to another aspect of an embodiment of the invention, an apparatus comprises a processor configured to receive a message including a group of keys for providing secure communication over a first broadcast network and a second broadcast network. The processor is further configured to receive a broadcast message specifying an encrypted service key, and the encrypted service key is decrypted using a portion of the group of keys.

According to yet another aspect of an embodiment of the invention, an apparatus comprises means for generating a message, including a group of keys and a filter address, for providing secure communication over a first broadcast network and a second broadcast network; means for transmitting the message to a terminal within the first broadcast network and a terminal within the second broadcast network; and means for broadcasting an encrypted service key to the terminals. The encrypted service key is decrypted using a portion of the group of keys, and the filter address indicates which of the terminals is entitled to use the service key.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1 is a diagram of an exemplary key management architecture supporting a cellular network and a broadcast network, in accordance with various embodiments of the invention;

FIG. 2 is a diagram of an exemplary key sharing procedure for key management utilized in a Universal Subscriber Identity Module (USIM)/Removable Universal Identity Module(R-) UIM profile, according to an embodiment of the invention;

FIG. 3 is a diagram of a structure of a key management message to deliver key set required for broadcast extensions, according to an embodiment of the invention;

FIG. 4 is a diagram of a structure of a key management message to deliver Service Encryption Key (SEK)/Program Encryption Key (PEK) using various addressing modes, according to an embodiment of the invention;

FIG. 5 is a diagram of an extension payload utilized with a SEK/PEK message for various addressing modes, according to an embodiment of the invention;

FIG. 6 is a diagram representing a key management for a USIM profile, according to an embodiment of the invention;

FIG. 7 is a flowchart for distributing service keys, according to various embodiments of the invention;

FIG. 8 is a diagram of hardware that can be used to implement an embodiment of the invention;

FIGS. 9A and 9B are diagrams of different cellular mobile phone systems capable of supporting various embodiments of the invention;

FIG. 10 is a diagram of exemplary components of a mobile station capable of operating in the systems of FIGS. 9A and 9B, according to an embodiment of the invention; and

FIG. 11 is a diagram of an enterprise network capable of supporting the processes described herein, according to an embodiment of the invention.

### DESCRIPTION OF THE PREFERRED EMBODIMENT

An apparatus, method, and software for delivering service keys to terminals of different radio systems are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a spread spectrum system and a digital video broadcast system, it is recognized by one of ordinary skill in the art that the embodiments of the inventions have applicability to any type of radio communication system as well as terrestrial networks. Additionally, it is contemplated that the protocols and processes described herein can be performed not only by mobile and/or wireless devices, but by any fixed (or non-mobile) communication device (e.g., desktop computer, network appliance, etc.) or network element or node.

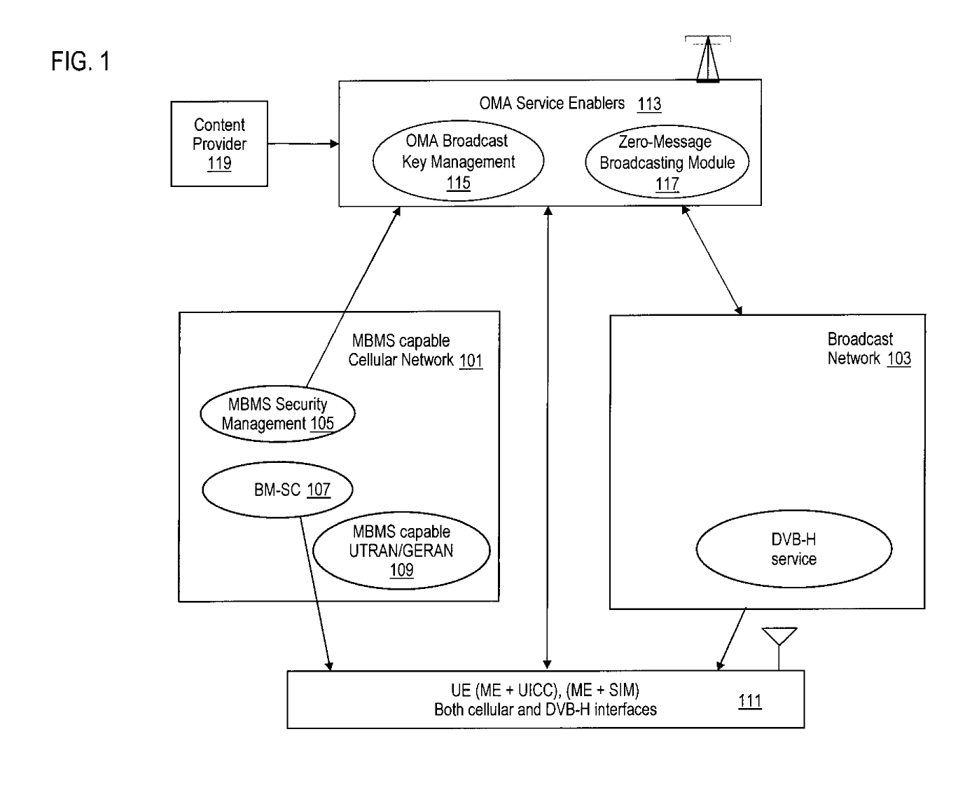

FIG. 1 is a diagram of an exemplary key management architecture supporting a cellular network and a broadcast network, in accordance with various embodiments of the invention. By way of example, the key management process is described with respect to two broadcast networks 101 and 103—such as an 3GPP (Third Generation Partnership Project) MBMS (Multimedia Broadcast Multicast Service) network for providing secure multicast/broadcast services to cellular subscribers and a DVB-H (Digital Video Broadcast-Handheld) network. However, the traditional 3GPP MBMS architecture is not scalable in a pure broadcast scenario, in which broadcast services have to be provided to a very large number of subscribers.

As shown, the MBMS capable cellular network 101 includes a MBMS security management component 105, a Broadcast Multicast—Service Center (BM-SC) component 107, and a MBMS capable UMTS Radio Access Network/GSM/EDGE Radio Access Network (UTRAN/GERAN) 109. The UTRAN/GERAN entities 109 are enhanced to provide the MBMS bearer service. Namely, these entities provide such functions as managing the MBMS bearer service activation status of user equipment (UE) 111 in case of multicast mode, outsourcing authorization decisions to the MBMS user service (i.e., to the BM-SC 107), and providing control of session initiation/termination by the MBMS user service and managing bearer resources (not shown) for the distribution of MBMS data.

The BM-SC 107 provides a set of functions for MBMS user services. The BM-SC 107 includes functions for MBMS user service provisioning and delivery. The BM-SC 107 may serve as an entry point for content provider MBMS transmissions, and be used to authorize and initiate MBMS bearer services. Additionally, the BM-SC 107 can also be used to schedule and deliver MBMS transmissions.

In the OMA (Open Mobile Alliance) BCAST (Broadcast) group, a scenario in which an operator provides broadcast service to both cellular subscribers and broadcast subscribers in a tightly coupled environment is contemplated. Under such a scenario, the operator can use a common service layer to provide services to the cellular network 101—e.g., UTRAN (UMTS (Universal Mobile Telecommunications Service) Radio Access Network)—and the broadcast network 103 such as a DVB-H (Digital Video Broadcast-Handheld) based radio network. DVB-H can be employed for transmitting video and audio clips over a wide area for a large, concentrated audience. With existing standards, the MBMS security mechanisms are inadequate to accommodate this scenario.

Hence, an approach, according to an exemplary embodiment, defines appropriate OMA BCAST enablers 113 that permit an operator to manage both cellular and broadcast subscribers. That is, the approach of the invention, according to one aspect, introduces an OMA BCAST enabler function 113 that facilitates a service provider to support, for example, both MBMS and BCAST users in an efficient manner (through group security mechanisms) in an integrated architecture.

The OMA BCAST enablers 113, in an exemplary embodiment, includes a key management module 115 (or entity) and a zero-message broadcasting module 117. The operation of these modules 115, 117 are more fully described below. A content provider 119 interfaces with the enablers 113 to supply video content, for example, video clips and mobile television. By way of example, video clips can be distributed over the cellular network 101, and mobile TV can be streamed over the DVB-H network 103. As noted, the MBMS security model allows for delivery of service keys in a point-to-point fashion to cellular subscribers. This, however, is not scalable in purely broadcast environments (e.g. DVB-H) where a service key has to be delivered in a point-to-point fashion to a large number of broadcast subscribers. The approach, in an exemplary embodiment, introduces an OMA BCAST enabler function that advantageously provides a scalable solution by delivering a set of group keys and appropriate filters to the terminals at registration time. Furthermore, the approach can prevent unauthorized subscribers to receive broadcast messages by, for instance, the zero-message broadcasting mechanism 117. This zero-message broadcasting mechanism 117 involves distributing secret information by a trusted authority among a set of users such that every user determine the keys corresponding to the privileged groups it belongs to.

To illustrate the effectiveness of the key management mechanism of the system of FIG. 1, two scenarios are considered. Under the first scenario, a cellular operator already has a large number of MBMS subscribers who already have MBMS security mechanisms built into their terminals. The operator now seeks to expand the subscriber base by introducing, for example, DVB-H base stations in the operator's network. According to one embodiment of the invention, the operator can use OMA-BCAST security enabler 113 to enhance its network, making the network more scalable, and thereby serving both cellular and broadcast subscribers.

A second scenario involves a cellular operator encounters a scalability problem with its MBMS network, as MBMS services grow in popularity the network will not readily accommodate the growth. In this case, the operator can employ the OMA BCAST security enabler 113 to serve a larger subscriber base.

In an exemplary embodiment, the OMA BCAST enabler 103 can efficiently deliver a service key to UICC (Universal Integrated Circuit Card) or SIM (Subscriber Identification Module) card based receivers. OMA BCAST compliant receivers 111 can derive additional keys SMK (Subscriber Management Key) and SAK (Subscriber Authentication Key). It is contemplated that other tamper resistant modules or storage medium can be utilized to store the service key.

Also, a key management protocol, in an exemplary embodiment, is utilized to deliver a set of broadcast keys to terminals to facilitate efficient delivery of service keys to the terminals. By way of the example, the protocol is based on the MIKEY (Multimedia Internet Key), which is detailed in RFC3830, and incorporated herein by reference in its entirety). According to one embodiment of the invention, messages are defined by using general extension payload. An OMA BCAST compliant device can be configured to support this mechanism.

As discussed, traditional MBMS/BCMCS key management approaches provide p-t-p (point-to-point) delivery of service (or long-term key) to terminals. However, there is a need for an efficient key management solution when service key has to be delivered to a large number of subscribers. According to one embodiment, the OMA BCAST service enabler 113 allows efficient delivery of service to a large number of users by using group key management mechanisms.

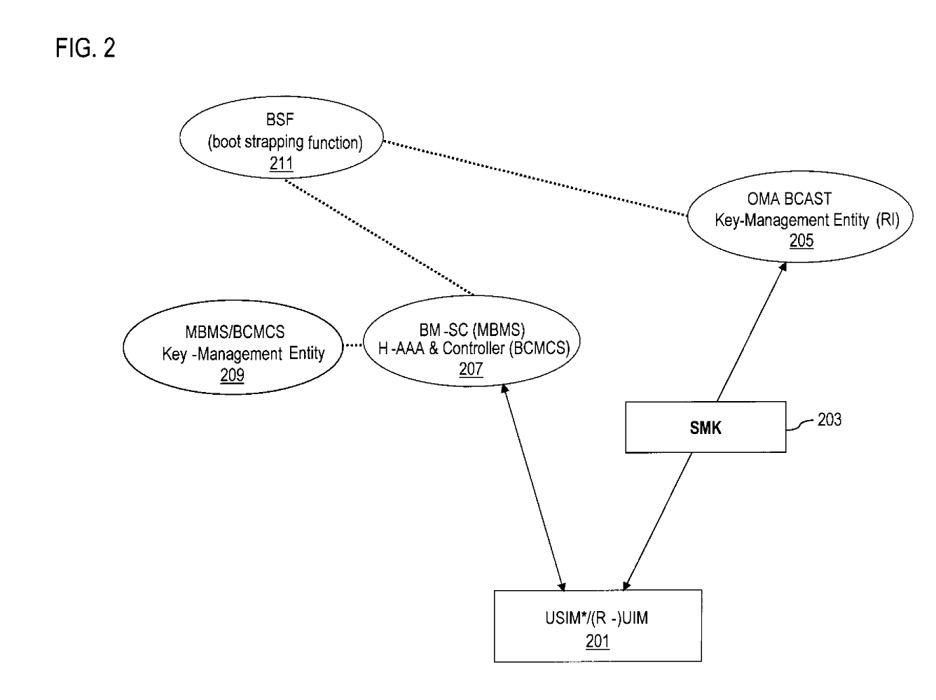

FIG. 2 is a diagram of an exemplary key sharing procedure for key management utilized in a Universal Subscriber Identity Module (USIM)/Removable Universal Identity Module(R-) UIM profile, according to an embodiment of the invention. Undoubtedly, secure service protection is vital for service providers. As explained, for service providers with a GSM (Global System for Mobile Communications) or UMTS (Universal Mobile Telecommunications Service) compliant network, a security framework is provided for broadcast defined based on, for instance, a smartcard 201—i.e. MBMS security based on smartcards and the Generic Bootstrapping Architecture (GBA) TS33.220, 3GPP2 networks supporting BCMCS provide a similar security framework based on (R-) UIM.

Security mechanisms of MBMS (Multimedia Broadcast Multicast Service) and BCMCS (Broadcast Multicast Services) can be largely reused for service protection of terminals that are equipped with a USIM or (R-) UIM 201. These security mechanisms are more fully explained in 3GPP TS 33.246 and 3GPP2 S.S0083, which are incorporated herein in their entireties. Table 1 below shows the MBMS keys:

TABLE 1

| | | | | GBA | | |
|---|---|---|---|---|---|---|
| | | | | Generic Bootstrapping | | |
| | | | | Architecture (GBA) extends | | |
| | | | | cellular authentication to | | |
| MBMS | | | | non-cellular services | | |
| Multimedia Broadcast/Multicast Service | | | | Normal GBA | GBA_U | |
| (MBMS) is point-to-multipoint service | | | | All operations | Key operations | |
| where a service is able to securely | | | | are performed | are divided | |
| transmit data to a given set of users. | | | | in ME (Mobile | between ME | |
| Key Name | Purpose | Type | Usage | Equipment) | and UICC | Remark |
| MTK MBMS | Data | Service | MTK is used to encrypt | Derived and | Derived in | MTK is always used to |
| Traffic | protection | specific | MBMS data in BM-SC, | used in the | UICC, used | decrypt MBMS data in ME |
| Key | | | and decrypt data in UE | ME | in ME | UE: MTK is derived |
| | | | | | | from MSK either in UICC |
| | | | | | | (GBA_U case) or in ME |
| | | | | | | (normal GBA case) |
| MSK MBMS | Data | Service | MSK is used to derive | Stored and | Stored and | MSK is generated by BM-SC |
| Service | protection | specific | the service specific | used in the | used in | (does not originate from |
| Key | | | MTKs. The MSK is longer | ME | UICC | GAA) UE: MSKs are stored |
| | | | lived than MTK. | | | in UICC (GBA_U) or in ME |
| | | | | | | (normal GBA). |
| MUK MBMS | Key | User | MUK is used to encrypt | Derived from | Ks_int_NAF | GBA is used to derive MUK |
| User Key | distribution | specific | the MSKs in the BM-SC | Ks_NAF in ME | (derived and | UE: MUK is used to decrypt |
| | | | before they are sent to | and in BM-SC | used in | MSKs in UICC (GBA_U) |
| | | | the UE using MIKEY. The | (derived and | UICC, not | or in ME (normal GBA). |
| | | | UE decrypts the MSKs | used in ME) | given to ME) | |
| | | | using the MUK. | | | |
| MRK MBMS | Authentication | User | Used to authenticate | Derived from | Ks_ext_NAF | GBA is used to derive MRK |
| Request | | specific | in the BM-SC the UE's | Ks_NAF in ME | (derived in | UE: MRK is derived in UICC |
| Key | | | request to the BM-SC | and BM-SC | UICC, given | (GBA_U) or in ME (normal |
| | | | (using HTTP Digest) | (derived and | and used in | GBA) and always used in ME. |
| | | | | used in ME) | ME) | |

Using the shared secret key that resides in the smartcard 201, a Subscriber Management Key (SMK) 203 is established between the smartcard 201 and the service provider or between the smartcard holding device and the service provider. SMK 203 is a user-specific key that can be used to protect Layer 2 messages.

In order to permit broadcasting of Layer 2 messages for efficient key distribution, an additional Group Management Key (GMK) (not shown) may be defined. GMK can be common to a group of users and used to protect the delivery of Layer 2 messages through a broadcast channel.

SMK 203 is shared with the RI 205 (i.e., OMA BCAST key management entity). Both SMK 203 and GMK can be stored within the smartcard 201 or the mobile terminal (not shown).

Service encryption key (SEK)/Program Encryption Key (PEK) is delivered protected by SMK 203 or GMK if a broadcast channel is used. As with the SMK and the GMK, the SEK/PEK can be stored within the smartcard 201 or the mobile terminal.

Traffic Key messages are protected using SEK/PEK. On receiving the Traffic Key message, the terminal sends to the SEK/PEK key holding entity either the encrypted TEK (Traffic Encryption Key) or information needed to generate the key that encrypt TEK. If the SEK/PEK resides in the smartcard then sends either TEK in the clear or the key that encrypts TEK to the terminal.

It is recognized that the USIM/UIM (or MBMS/BCMCS) profile for BCAST may require further mechanisms to facilitate efficient delivery of long-term service key to a group of terminals. Traditionally, MBMS allows point to point delivery of MSK (master service key) encrypted using MUK (MBMS User Key) shared between UICC (Universal Integrated Circuit Card) and BM-SC (Broadcast Multicast-Service Center) 207. BCMCS uses a temporary key (TK), which is derived from the registration key (RK) shared between H-AAA and (R-) (Removable) UIM to achieve the same purpose. Similar to OMA DRM (Digital Rights Management) profile, a mechanism is needed to deliver key set to support OMA BCAST extensions. An exemplary key set to be delivered to the terminal is given in Table 2, below.

TABLE 2

| Name | | |
|---|---|---|
| of Key | Description | Comments |
| UGK | Unique Group Key | UGK is used to derive group |
| | | management key (GMK). This can |
| | | be denoted as DEK in subsequent |
| | | paragraphs in order to be consistent |
| | | with OMA DRM profile |
| BGK | Broadcast Group | Used for zero message broadcast; |
| | Key(s) | BGKs are also used to derive group |
| | | management key (GMK). This can |
| | | be denoted as DEK in subsequent |
| | | paragraphs in order to be consistent |
| | | with OMA DRM profile. |
| UDK | Unique Device Key | Device specific key |
| RIAK | RI Authentication | Authentication key to authenticate |
| | Key | payload that carries MSK to a |
| | | group of users. RIAK can also be |
| | | implicitly derived by the terminal |
| | | using UGK and MIKEY_RAND |
| | | value transported in MIKEY SEK |
| | | message. |
| UDF | Unique Device | Eurocrypt address, not a key |
| | Filter | |

3GPP MBMS, for instance, uses GBA (which is more fully described in TS33.220, which is incorporated herein by reference in its entirety) to generate a shared key MRK (MBMS Request Key) (for user authentication) and a shared key MUK (for service key (MSK) delivery). MBMS uses two variations of GBA via a bootstrapping function (BSF) 211: GBA_U (GBA with UICC-based enhancement) and GBA_ME (ME-based GBA).

GBA_U generates both keys in the UICC using Ks_int_NAF (=MUK) and Ks_ext_NAF (=MRK). UICC later forwards MRK to ME (Mobile Equipment). It is noted that the KDF (Key Derivation Function) used to generate these keys are identical; however, the key derivation parameters used for Ks_ext_NAF derivation are different from those used for Ks_int_NAF derivation. This can be performed by including a static string “gba-me” in Ks_ext_NAF(=Ks_NAF=KDF (Ks, “gba-me”, RAND, IMPI, NAF_Id))and “gba-u” in Ks_int_NAF (=Ks_NAF=KDF (Ks, “gba-u^{t”, RAND, IMPI, NAF}_Id) as an input parameter to the key derivation function.

Alternatively, MBMS uses GBA_ME when a terminal is without GBA (Generic Bootstrapping Architecture) aware UICC. In this case ME generates Ks_NAF(=Ks_NAF=KDF (Ks, “gba-me”, RAND, IMPI, NAF_Id)), which is used as MUK (MBMS User Key) and MRK (MBMS Registration Key) is derived from Ks_NAF (see Appendix).

A clean separation between standard 3GPP MBMS/BCMCS implementations and OMA BCAST smartcard implementations can be provided by generating a shared key SMK (Subscriber Management Key) 203 between UICC/UIM 201 and OMA BCAST entity (RI) 205. RI is the OMA BCAST entity for key management. The RI terminology originates from the OMA DRM profile. This can be achieved in different ways: USIM can run GBA to generate shared secret SMK between UICC and equivalent OMA BCAST entity (RI) by using static string “bcast-u” as input parameter in the key derivation function (KDF) to generate SMK as Ks_int_NAF_SMK=KDF(Ks_int_NAF, “beast-u”, NAF_Id) [for GBA_U] or Ks_NAF_SMK=KDF(Ks_NAF, “bcast-u”,NAF_ID) [for GBA_ME], where NAF_Id is full DNS (Domain Name System) name of the equivalent OMA BCAST entity (RI). It is noted that for GBA_ME, all keys can be stored in ME. In addition, SAK (Subscriber Authentication Key) is derived as Ks_ext NAF_SAK=(Ks_ext_NAF,“bcast_u”,NAF_Id)[for GBA_U], or Ks_NAF_SAK=KDF (Ks_NAF,“bcast_u”,NAF_ID)[for GBA_ME]. SAK is used for user authentication by RI, when a user wants to subscribe to a BCAST service.

In another embodiment, application identifier in the NAF_ID can be used to derive OMA BCAST specific SMK key in UICC. The NAF_ID can be concatenated with four octets identifying an application protocol. The application protocol identifier needs to be used to achieve key separation between different applications using the same NAF (Network Application Function). By way of example, 0x03,0x00,0x00,0x01 can be used for OMA BCAST GBA as a protocol identifier (3GPP MBMS uses 0x01,0x00,0x00,0x01). Thus, the NAF specific keys are also applications protocol specific.

For, (R-)UIM a shared secret SMK can be pre provisioned between OMA BCAST entity and UIM.

SMK 203 can then be used to encrypt rest of the parameters in key set block (UGK (Unique Group Key), BGK (Broadcast Group Key), UDK (Unique Device Key), RIAK (RI Authentication Key) and UDF (Unique Device Filter)). The encrypted key set block is then delivered to a terminal in a point-to-point fashion using MIKEY (Multimedia Internet Key) message. The key set block parameters are stored in UICC/(R-) UIM.

With OMA BCAST USIM/(R-) UIM profile, the service key (SEK/PEK) can be broadcast to a group of terminals in a single message. SEK/PEK is encrypted using DEK that is derived from UGK, BGK(s) or UDK. The derivation, according to one embodiment, can be performed using the procedure of the OMA DRM profile.

The notation HMAC_SHA1{k}(s) is used to denote the computation of HMAC (as described in RFC2104, which is incorporated herein in its entirety) with SHA1 (as described in FIPS 180.2, which is incorporated herein in its entirety) as the hash function keyed by the key ‘k’ over the string ‘s’. IIMAC SHA1_{—}128{k}(s) is used to denote the 128 most significant bits of HMAC_SHA1{k}(s) output.

A key DEK (Derived Key) is “derived” from the UGK, BGK or UDK such that

DEK=HMAC_SHA1_{—}128{UGK}{MIKEY-RAND} or

DEK=HMAC_SHA1_{—}128{BGK_i ∥ . . . ∥BGK_j}{MIKEY_RAND},

where the BGK's are BGK keys ordered according to the index (such that i<j) that are required for creating the key for the desired group; or

DEK=HMAC_SHA1_{—}128{UDK}(MIKEY_RAND)

The DEK is used to decrypt the part of the MIKEY message (layer 2 message for USIM profile) containing service key/program key (SEK/PEK). The MIKEY-RAND is a random value carried in the MIKEY message. It is noted that (R-) UIM May use different layer 2 message to achieve the same purpose.

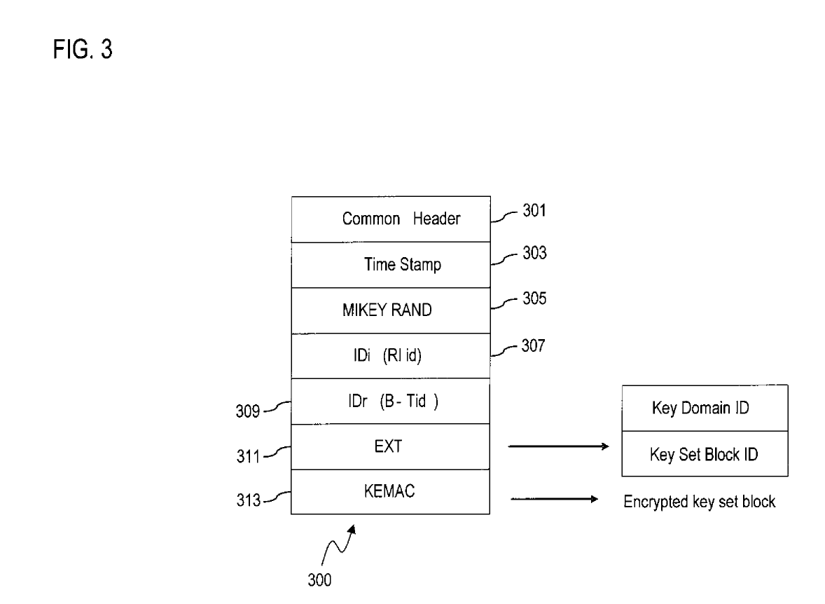

FIG. 3 is a diagram of a structure of a key management message to deliver key set required for broadcast extensions, according to an embodiment of the invention. For purposes of illustration the protocol for exchanging the key set is MIKEY. An exemplary structure of a MIKEY message 300 carrying key set data is depicted in FIG. 3; the structure includes a common header field 301, a time stamp (TS) field 303, a MIKEY RAND field 305, an IDi field 307, an IDr field 309, an extension (EXT) payload field 311, and a KEMAC field 313. The message 300, in one embodiment, can be sent to a terminal at registration time. The MIKEY_RAND 305 is used to derive, for example, encryption and authentication keys from the received keys. The identity payloads of the initiator's and responder's IDs shall be included in the key set transport message structure. IDi 307 is the ID of the RI and IDr 309 is the ID of the UE's username (i.e. B-TID). The encrypted key set (e.g., key set encrypted using SMK 203) is carried in the KEMAC (key data transport payloads) 313. In an exemplary embodiment, the time stamp field 303 is a 32-bit counter to guard against replay attack. A Key Group ID is carried in EXT header 311, and values for the Key Group ID are defined in 3GPP TS 33.246. The EXT header 311 may also carry addition key set block ID, for example.

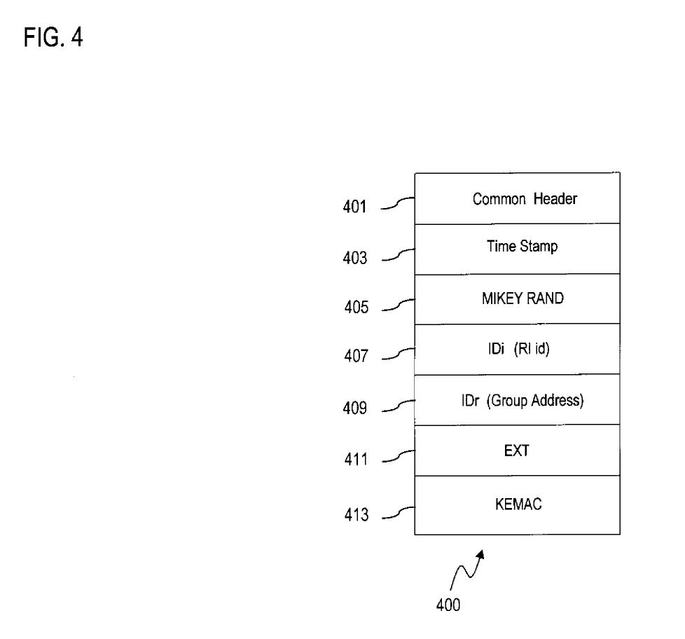

FIG. 4 is a diagram of a structure of a key management message to deliver Service Encryption Key (SEK)/Program Encryption Key (PEK) using various addressing modes, according to an embodiment of the invention. In this example, a MIKEY message 400 carries a SEK/PEK. Similar to the format of the MIKEY message 300 of FIG. 3, the message 400 includes a common header field 401, a time stamp (TS) field 403, a MIKEY RAND field 405, an IDi field 407, an IDr field 409, an EXT field 411, and a KEMAC field 413. The data type field in the EXT header 411 is extended to support various addressing modes (e.g., unique group, broadcast group and unique device), as specified below in Table 3:

TABLE 3

| Data Type | Comment |
|---|---|
| Unique Group | MIKEY message carries SEK/PEK addressed to a |
| | unique group. |
| Broadcast Group | MIKEY message carries SEK/PEK addressed to a |
| | broadcast group. |
| Unique Device | MIKEY message carries SEK/PEK addressed to a |
| | unique device within a unique group. |

The MIKEY_RAND 405 is used to derive, for example, encryption and authentication keys from the received service key. MIKEY_RAND 405 is additionally used to derive DEK as described previously.

The identity payloads of the initiator's and responder's IDs are included in the key set transport message structure, wherein the IDi field 407 is the ID of the RI, and the IDr field 409 is the ID of the UE's username. According to one embodiment of the invention, the IDr field 409 can specify the group address. The group address is part of the unique device filter (UDF) address that is sent in the MIKEY carrying key set for the terminal. The encrypted SEK/PEK (encrypted using DEK) is carried in the KEMAC 413 (carries DEK encrypted SEK/PEK). The EXT header 411 carries Key Domain ID and SEK ID/PEK ID fields that are common to all addressing modes. In addition, the EXT header 411 may carry SEK-ID/PEK-ID as well as additional information depending upon the addressing mode that is specific to a particular addressing mode.

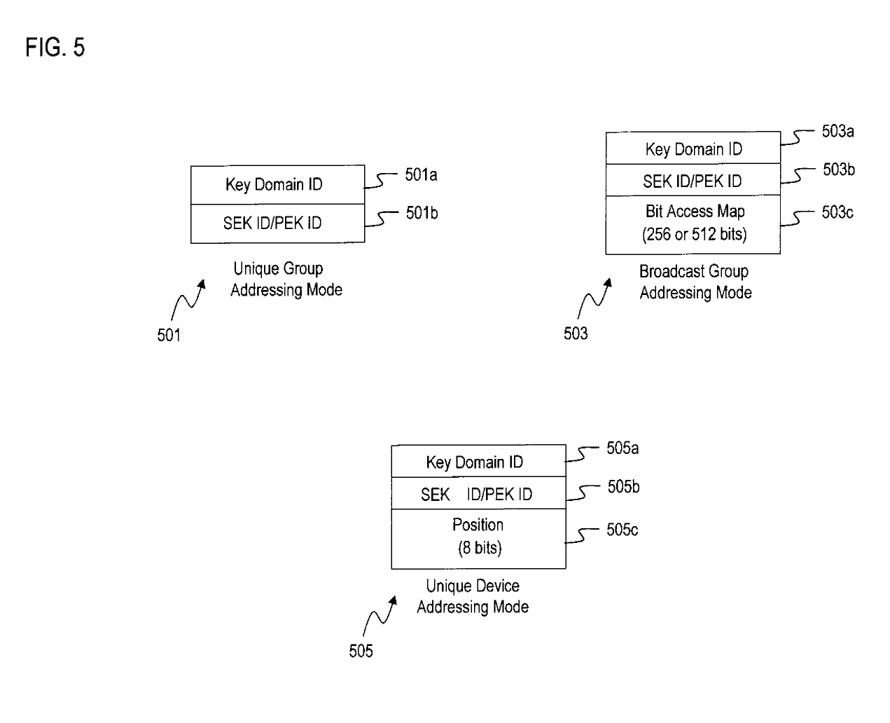

FIG. 5 is a diagram of an extension payload utilized with a SEK/PEK message for various addressing modes, according to an embodiment of the invention. The extension payload formats (e.g., EXT fields 311, 411) used for different addressing modes are depicted. Format 501 corresponds to a unique group addressing mode, and includes a key domain ID field 501a and a SEK ID/PEK ID field 501b. As for the broadcast group addressing mode, format 503 includes a key domain ID field 503a and a SEK ID/PEK ID field 503b as with the format 501, but with the addition of a bit access map field 503c. In an exemplary embodiment, the bit access map field 503c carries Eurocrypt-style “Bit Access Map” parameter, which prescribes the particular group members that are “entitled” to use the SEK/PEK. In other words, the field 503c indicates which group members of the broadcast group can deduce the broadcast key for the zero message broadcast keys in the UICC.

With respect to the unique device addressing mode, the format 505 includes a key domain ID field 505a, a SEK ID/PEK ID field 505b, and a “Position” field 505c. The EXT header for unique addressing mode carries a “Position” field. The unique address is a group address plus a “Position” in the group. This address matches the unique-device-filter address that was sent earlier to the terminal at the time of registration.

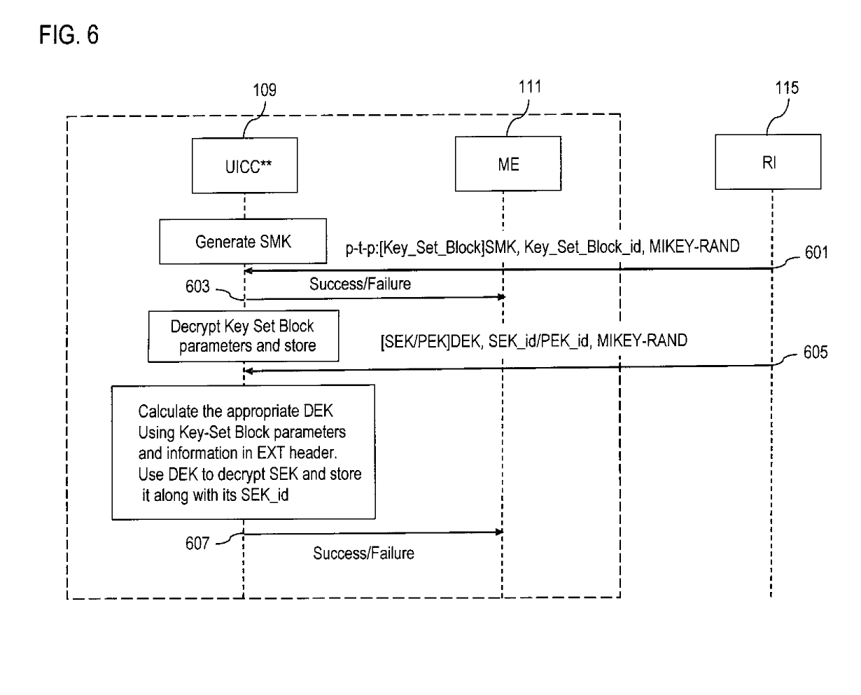

FIG. 6 shows a diagram representing a key management for a USIM profile, according to an embodiment of the invention. (R-)UIM can use a pre-provisioned shared secret (RK: registration key) shared between UIM and OMA BCAST entity (RI), such as RI 115. Also, RI 115 can use equivalent BCMCS layer 2 messages to transport key set block parameters and service keys to (R-) UIM.

In step 601, the OMA key management entity (RI) 115 sends p-t-p:[Key_Set_Block]SMK, Key_Set_Block_id, MIKEY-RAND to UICC 109 to generate Subscriber Management Key (SMK). The UICC 109 then notifies success/failure notice to ME 111, per step 603. Next, the RI 119, per step 605, sends [SEK/PEK]DEK, SEK_id/PEK_id, MIKEY-RAND to UICC 109 to decrypt key set block parameters and to store. In response, the UICC 109 calculates the appropriate DEK using Key-Set Block parameters and information in EXT header. UICC 109 can use DEK to decrypt SEK and store it along with its SEK_id. In step 607, the UICC 109 then sends success/failure notice to ME 111. It is noted that it is ME 111 if GBA_ME is for key management in MBMS.

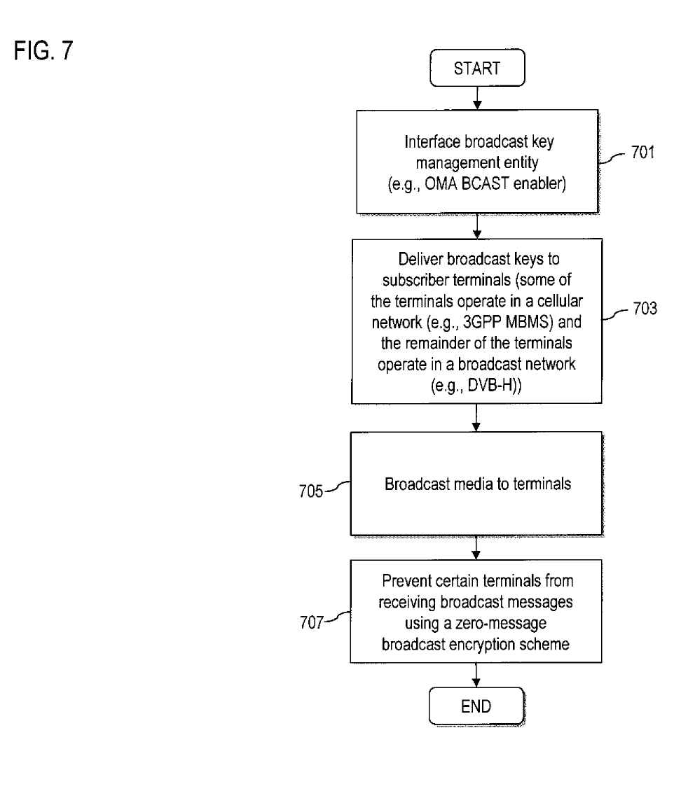

FIG. 7 is a flowchart for distributing service keys, according to various embodiments of the invention. In step 701, the smartcard or terminal interfaces with a broadcast key management entity (RI). The terminals can enable both cellular and DVB-H, interfaces with broadcast key management entity (RI) 115. The RI delivers, per step 703, broadcast keys to subscriber terminals (some of the terminals operate in a cellular network (e.g., 3GPP MBMS), and the remainder of the terminals operate in the broadcast network (e.g., DVB-H)). In step 705, RI 115 broadcast media to the terminals. The entity RI 115 prevents certain terminals from receiving broadcast messages using a zero-message broadcast encryption scheme.

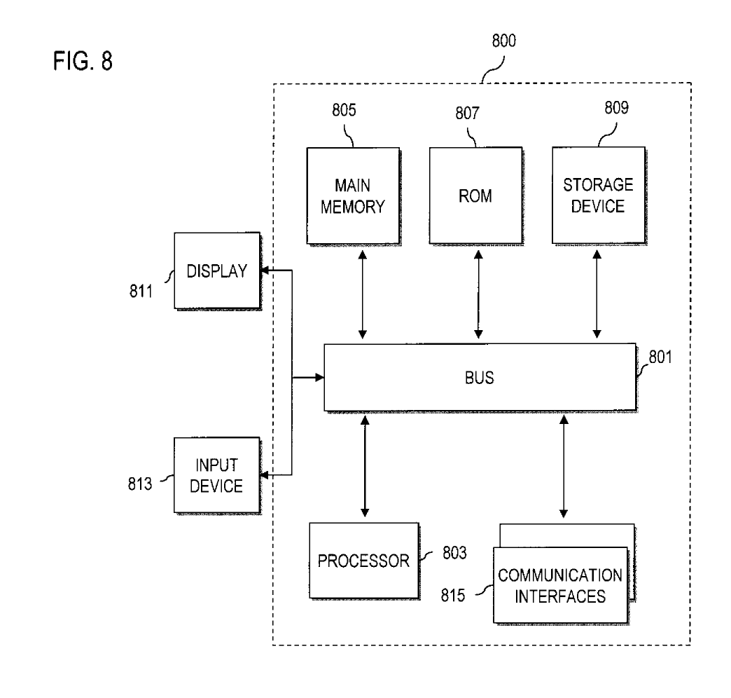

One of ordinary skill in the art would recognize that the above key processes may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 8.

FIG. 8 illustrates exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled via the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

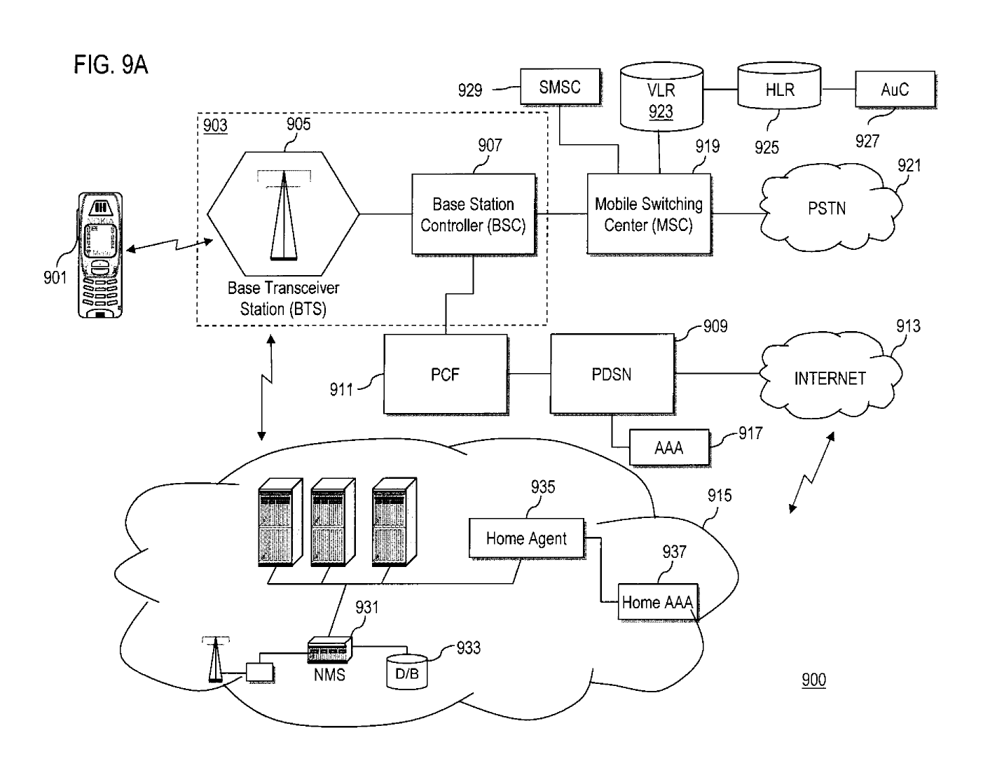

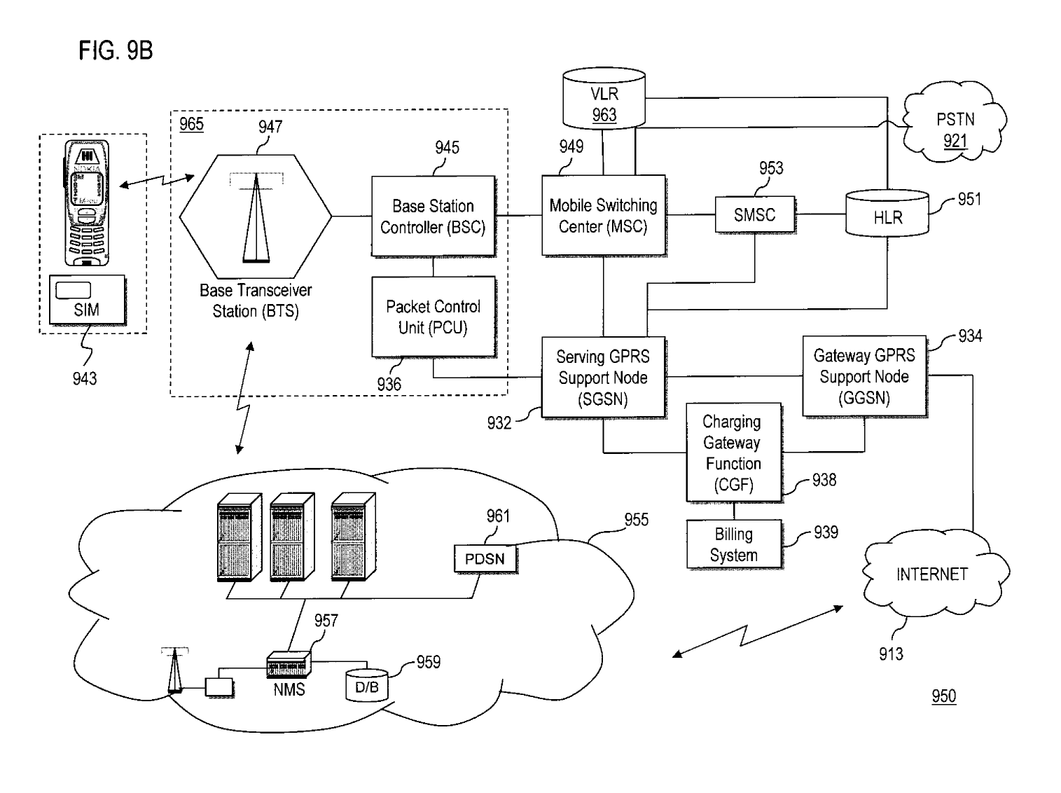

FIGS. 9A and 9B are diagrams of different cellular mobile phone systems capable of supporting various embodiments of the invention. FIGS. 9A and 9B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 900 includes mobile stations 901 (e.g., handsets, terminals, stations, units, devices, or any type of interface to the user (such as “wearable” circuitry, etc.)) in communication with a Base Station Subsystem (BSS) 903. According to one embodiment of the invention, the radio network supports Third Generation (30) services as defined by the International Telecommunications Union (ITU) for International Mobile Telecommunications 2000 (IMT-2000).

In this example, the BSS 903 includes a Base Transceiver Station (BTS) 905 and Base Station Controller (BSC) 907. Although a single BTS is shown, it is recognized that multiple BTSs are typically connected to the BSC through, for example, point-to-point links. Each BSS 903 is linked to a Packet Data Serving Node (PDSN) 909 through a transmission control entity, or a Packet Control Function (PCF) 911. Since the PDSN 909 serves as a gateway to external networks, e.g., the Internet 913 or other private consumer networks 915, the PDSN 909 can include an Access, Authorization and Accounting system (AAA) 917 to securely determine the identity and privileges of a user and to track each user's activities. The network 915 comprises a Network Management System (NMS) 931 linked to one or more databases 933 that are accessed through a Home Agent (HA) 935 secured by a Home AAA 937.

Although a single BSS 903 is shown, it is recognized that multiple BSSs 903 are typically connected to a Mobile Switching Center (MSC) 919. The MSC 919 provides connectivity to a circuit-switched telephone network, such as the Public Switched Telephone Network (PSTN) 921. Similarly, it is also recognized that the MSC 919 may be connected to other MSCs 919 on the same network 900 and/or to other radio networks. The MSC 919 is generally collocated with a Visitor Location Register (VLR) 923 database that holds temporary information about active subscribers to that MSC 919. The data within the VLR 923 database is to a large extent a copy of the Home Location Register (HLR) 925 database, which stores detailed subscriber service subscription information. In some implementations, the HLR 925 and VLR 923 are the same physical database; however, the HLR 925 can be located at a remote location accessed through, for example, a Signaling System Number 7 (SS7) network. An Authentication Center (AuC) 927 containing subscriber-specific authentication data, such as a secret authentication key, is associated with the HLR 925 for authenticating users. Furthermore, the MSC 919 is connected to a Short Message Service Center (SMSC) 929 that stores and forwards short messages to and from the radio network 900.

During typical operation of the cellular telephone system, BTSs 905 receive and demodulate sets of reverse-link signals from sets of mobile units 901 conducting telephone calls or other communications. Each reverse-link signal received by a given BTS 905 is processed within that station. The resulting data is forwarded to the BSC 907. The BSC 907 provides call resource allocation and mobility management functionality including the orchestration of soft handoffs between BTSs 905. The BSC 907 also routes the received data to the MSC 919, which in turn provides additional routing and/or switching for interface with the PSTN 921. The MSC 919 is also responsible for call setup, call termination, management of inter-MSC handover and supplementary services, and collecting, charging and accounting information. Similarly, the radio network 900 sends forward-link messages. The PSTN 921 interfaces with the MSC 919. The MSC 919 additionally interfaces with the BSC 907, which in turn communicates with the BTSs 905, which modulate and transmit sets of forward-link signals to the sets of mobile units 901.

As shown in FIG. 9B, the two key elements of the General Packet Radio Service (GPRS) infrastructure 950 are the Serving GPRS Supporting Node (SGSN) 932 and the Gateway GPRS Support Node (GGSN) 934. In addition, the GPRS infrastructure includes a Packet Control Unit PCU (936) and a Charging Gateway Function (CGF) 938 linked to a Billing System 939. A GPRS the Mobile Station (MS) 941 employs a Subscriber Identity Module (SIM) 943.

The PCU 936 is a logical network element responsible for GPRS-related functions such as air interface access control, packet scheduling on the air interface, and packet assembly and re-assembly. Generally the PCU 936 is physically integrated with the BSC 945; however, it can be collocated with a BTS 947 or a SGSN 932. The SGSN 932 provides equivalent functions as the MSC 949 including mobility management, security, and access control functions but in the packet-switched domain. Furthermore, the SGSN 932 has connectivity with the PCU 936 through, for example, a Fame Relay-based interface using the BSS GPRS protocol (BSSGP). Although only one SGSN is shown, it is recognized that that multiple SGSNs 931 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 945, any given BSC 945 generally interfaces with one SGSN 932. Also, the SGSN 932 is optionally connected with the HLR 951 through an SS7-based interface using GPRS enhanced Mobile Application Part (MAP) or with the MSC 949 through an SS7-based interface using Signaling Connection Control Part (SCCP). The SGSN/HLR interface allows the SGSN 632 to provide location updates to the HLR 951 and to retrieve GPRS-related subscription information within the SGSN service area. The SGSN/MSC interface enables coordination between circuit-switched services and packet data services such as paging a subscriber for a voice call. Finally, the SGSN 932 interfaces with a SMSC 953 to enable short messaging functionality over the network 950.

The GGSN 934 is the gateway to external packet data networks, such as the Internet 913 or other private customer networks 955. The network 955 comprises a Network Management System (NMS) 957 linked to one or more databases 959 accessed through a PDSN 961. The GGSN 934 assigns Internet Protocol (IP) addresses and can also authenticate users acting as a Remote Authentication Dial-In User Service host. Firewalls located at the GGSN 934 also perform a firewall function to restrict unauthorized traffic. Although only one GGSN 934 is shown, it is recognized that a given SGSN 932 may interface with one or more GGSNs 933 to allow user data to be tunneled between the two entities as well as to and from the network 950. When external data networks initialize sessions over the GPRS network 950, the GGSN 934 queries the HLR 951 for the SGSN 932 currently serving a MS 941.

The BTS 947 and BSC 945 manage the radio interface, including controlling which Mobile Station (MS) 941 has access to the radio channel at what time. These elements essentially relay messages between the MS 941 and SGSN 932. The SGSN 932 manages communications with an MS 941, sending and receiving data and keeping track of its location. The SGSN 932 also registers the MS 941, authenticates the MS 941, and encrypts data sent to the MS 941.

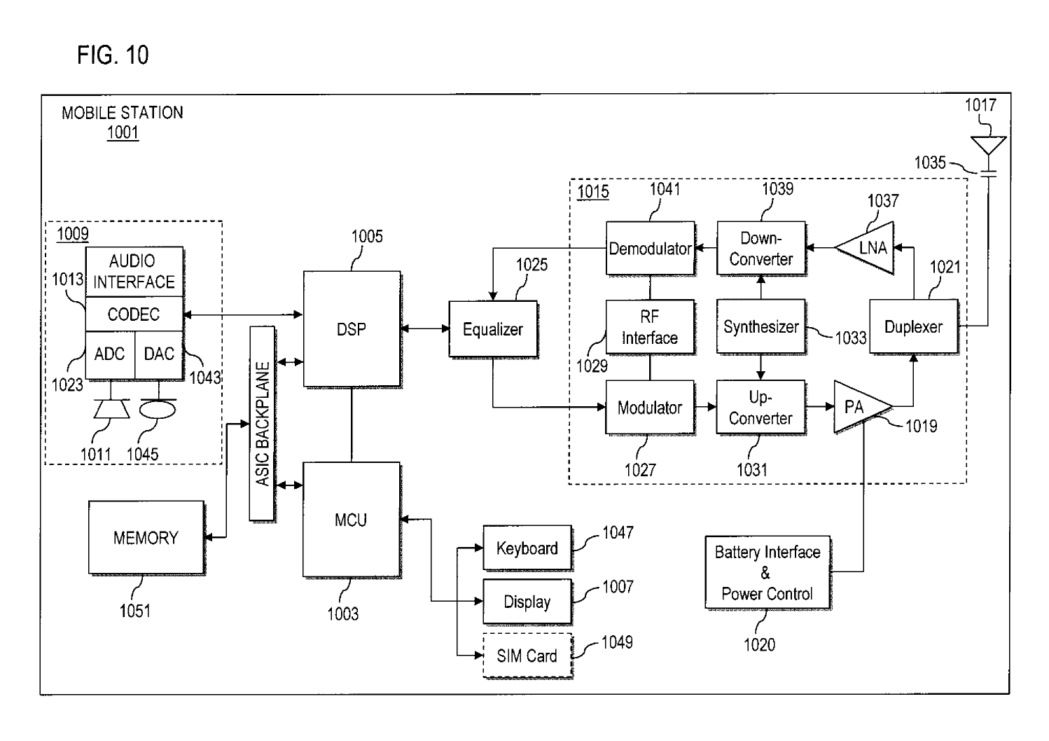

FIG. 10 is a diagram of exemplary components of a mobile station (e.g., handset) capable of operating in the systems of FIGS. 9A and 9B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system (e.g., systems of FIG. 9A or 9B), via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 739 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

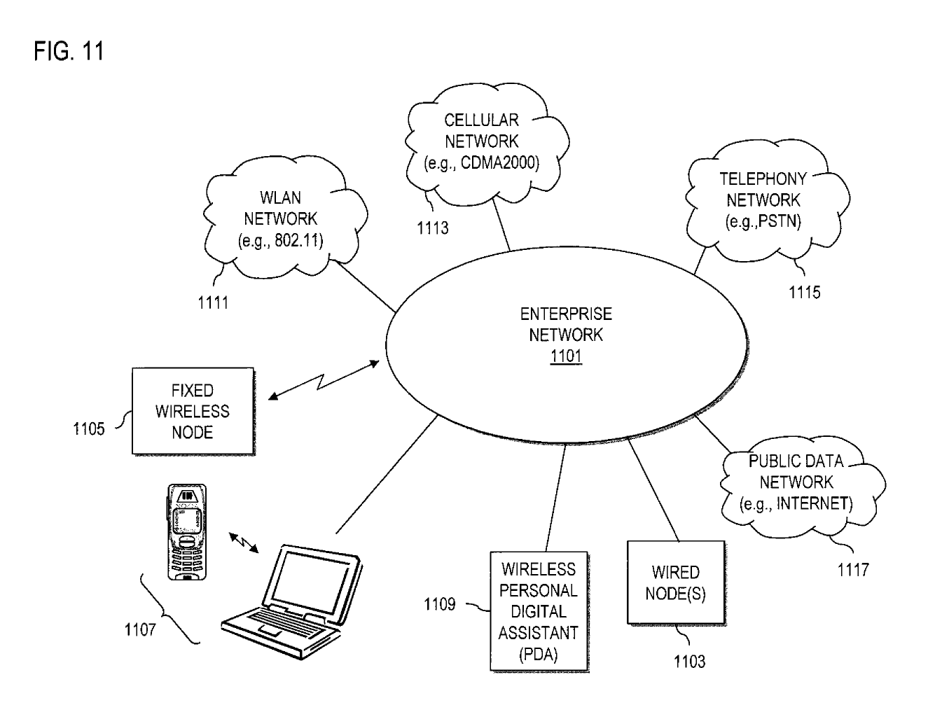

FIG. 11 shows an exemplary enterprise network, which can be any type of data communication network utilizing packet-based and/or cell-based technologies (e.g., Asynchronous Transfer Mode (ATM), Ethernet, IP-based, etc.). The enterprise network 1101 provides connectivity for wired nodes 803 as well as wireless nodes 1105-1109 (fixed or mobile), which are each configured to perform the processes described above. The enterprise network 1101 can communicate with a variety of other networks, such as a WLAN network 1111 (e.g., IEEE 802.11), a cdma2000 cellular network 1113, a telephony network 1116 (e.g., PSTN), or a public data network 1117 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
generating a message including a group of keys for providing secure communication over a first broadcast network and a second broadcast network;
transmitting the message to a terminal within the first broadcast network and a terminal within the second broadcast network; and
broadcasting an encrypted service key to the terminals, wherein the encrypted service key is decrypted using a portion of the group of keys.

2. A method according to claim 1, wherein the transmitting step is performed during registration of the terminal for a service provided by one of the broadcast networks.

3. A method according to claim 1, wherein the group of keys includes a unique group key, a broadcast group key and a unique device key for deriving a group management key identifying a group of users, and the message further includes a filter address specifying which of the terminals can deduce the broadcast group key.

4. A method according to claim 3, wherein the broadcast group key is used to prevent receipt of broadcast messages through a zero-message broadcasting mechanism.

5. A method according to claim 1, wherein the first broadcast network includes a cellular network and the second broadcast network includes a radio network.

6. A method according to claim 1, wherein the terminal includes a module configured to store the group of keys, the module being either a universal integrated circuit card, a smartcard, a subscriber identification module, or a tamper resistant module.

7. A method according to claim 1, wherein the message is generated according to a multimedia Internet key (MIKEY) protocol.

8. A method according to claim 1, wherein the group of keys is delivered to the terminal using a personal key that is derived from a secret stored in a tamper resistant module within the terminal.

9. A method according to claim 1, wherein one or more of the keys are derived using a Generic Bootstrapping Architecture (GBA).

10. An apparatus comprising:
a key management entity configured to generate a message including a group of keys for providing secure communication over a first broadcast network and a second broadcast network, wherein the message is transmitted to a terminal within the first broadcast network and a terminal within the second broadcast network,
wherein an encrypted service key is broadcast to the terminals, and the encrypted service key is decrypted using a portion of the group of keys.

11. An apparatus according to claim 10, wherein the transmission of the message is performed during registration of the terminal for a service provided by one of the broadcast networks.

12. An apparatus according to claim 10, wherein the group of keys includes a unique group key, a broadcast group key and a unique device key for deriving a group management key identifying a group of users.

13. An apparatus according to claim 12, wherein the broadcast group key is used to prevent receipt of broadcast messages through a zero-message broadcasting mechanism, and the message further includes a filter address specifying which of the terminals can deduce the broadcast group key.

14. An apparatus according to claim 10, wherein the first broadcast network includes a cellular network and the second broadcast network includes a radio network.

15. An apparatus according to claim 10, wherein the terminal includes a module configured to store the group of keys, the module being either a universal integrated circuit card, a smartcard, a subscriber identification module, or a tamper resistant module.

16. An apparatus according to claim 10, wherein the message is generated according to a multimedia Internet key (MIKEY) protocol.

17. An apparatus according to claim 10, wherein the group of keys is delivered to the terminal using a personal key that is derived from a secret stored in a tamper resistant module within the terminal.

18. An apparatus according to claim 10, wherein one or more of the keys are derived using a Generic Bootstrapping Architecture (GBA).

19. A system comprising the apparatus of claim 10, the system further comprising:
a transceiver configured to transmit the message and to broadcast the encrypted service key.

20. A method comprising:
receiving a message including a group of keys for providing secure communication over a first broadcast network and a second broadcast network;
receiving a broadcast message specifying an encrypted service key; and
decrypting the encrypted service key using a portion of the group of keys.

21. A method according to claim 20, wherein the message is received as part of a registration process for a service provided by one of the broadcast networks.

22. A method according to claim 20, wherein the group of keys includes a unique group key, a broadcast group key and a unique device key for deriving a group management key identifying a group of users.

23. A method according to claim 22, wherein the broadcast group key is used to prevent receipt of broadcast messages through a zero-message broadcasting mechanism, the method further comprising:
determining whether a predetermined group address matches the filter address to enable use of the service key.

24. A method according to claim 20, wherein the first broadcast network includes a cellular network and the second broadcast network includes a radio network.

25. A method according to claim 20, wherein the group of keys are stored in either a universal integrated circuit card, a smartcard, a subscriber identification module, or a tamper resistant module.

26. A method according to claim 20, wherein the message is received according to a multimedia Internet key (MIKEY) protocol, and one or more of the keys are derived using a Generic Bootstrapping Architecture (GBA).

27. An apparatus comprising:
a processor configured to receive a message including a group of keys for providing secure communication over a first broadcast network and a second broadcast network, wherein the processor is further configured to receive a broadcast message specifying an encrypted service key, and the encrypted service key is decrypted using a portion of the group of keys.

28. An apparatus according to claim 27, wherein the message is received as part of a registration process for a service provided by one of the broadcast networks.

29. An apparatus according to claim 27, wherein the group of keys includes a unique group key, a broadcast group key and a unique device key for deriving a group management key identifying a group of users.

30. An apparatus according to claim 29, wherein the broadcast group key is used to prevent receipt of broadcast messages through a zero-message broadcasting mechanism, and the processor is further configured to determine whether a predetermined group address matches the filter address to enable use of the service key.

31. An apparatus according to claim 27, wherein the first broadcast network includes a cellular network and the second broadcast network includes a radio network.

32. An apparatus according to claim 27, wherein the group of keys are stored in either a universal integrated circuit card, a smartcard, a subscriber identification module, or a tamper resistant module.

33. An apparatus according to claim 27, wherein the message is received according to a multimedia Internet key (MIKEY) protocol, and one or more of the keys are derived using a Generic Bootstrapping Architecture (GBA).

34. A system comprising the apparatus of claim 27, the system further comprising:
a transceiver configured to receive the message and the broadcast message.

35. An apparatus comprising:
means for generating a message, including a group of keys and a filter address, for providing secure communication over a first broadcast network and a second broadcast network;
means for transmitting the message to a terminal within the first broadcast network and a terminal within the second broadcast network; and
means for broadcasting an encrypted service key to the terminals, wherein the encrypted service key is decrypted using a portion of the group of keys, and the filter address indicates which of the terminals is entitled to use the service key.

36. A method according to claim 35, wherein the transmission of the message is performed during registration of the terminal for a service provided by one of the broadcast networks.
